(19) United States
(12) Patent Application Publication
(10) Pub. No.: US 2003/0199594 A1
(43) Pub. Date: Oct. 23, 2003

(54) Helium propellant composition for use with aerosols

(76) Inventor: Rasik Shah, New York, NY (US)

Correspondence Address: LARSON & TAYLOR, PLC, 1199 NORTH FAIRFAX STREET, SUITE 900, ALEXANDRIA, VA, 22314, US

(21) Appl. No.: 10/127,537

(22) Filed: Apr. 23, 2002

(51) Int. Cl. B01F 3/04

(52) U.S. Cl. 516/1

(57) ABSTRACT

The invention relates to a new propellant composition for use with aerosols such as may be used in medical devices such as a metered dose inhaler (or MDI) or a nasal spray device. The propellant features helium as its primary ingredient, preferably at least about 70% and most preferably at or around 100% by weight of the propellant composition, and this propellant can be used in a variety of applications since it is both inert and environmentally safe. The propellant of the invention can thus be utilized advantageously as a safe and environmentally friendly alternative to many current propellants including those based on hydrofluorocarbons (e.g., HFA), fluorocarbons (e.g., CFC), or hydrocarbons such as butane and propane. A series of aerosol formulations which use the new propellant are also provided as well as a method for using these aerosol composition to treat a variety of medical ailments, including bronchial asthma and rhinitis, and the formulations may be utilized in the delivery of bronchodilators and other suitable substances for these and other therapeutic methods.

### BACKGROUND OF THE INVENTION

1. Field of the Invention

The invention relates generally to the field of aerosol propellants, and more specifically to an improved propellant composition which includes helium as its primary ingredient.

2. Related Art

Aerosol propellants are any gas, solid or liquid of which the expansion can be used to impart motion to another substance or object. Aerosol propellants are particularly useful when used to propel substances or a solution into the smallest possible particle at a desired speed to reach a desired place. Most modern aerosols use some form of liquefied or compressed gas as a propellant. These propellants are formed by putting the gas under high pressure thus turning it into a liquid. Traditionally, these propellants were mixtures of simple hydrocarbons such as butane and propane. A major disadvantage of these types of propellants is that they are flammable, and thus for safety reasons they cannot be used in many applications.

ChloroFluoroCarbons, commonly known as a CFCs, are another type of frequently used aerosol propellant. CFCs were preferred over traditional hydrocarbon mixtures since they were not flammable and possessed advantageous chemical properties which enabled them to be used in a variety of different formulations. However, one major disadvantage associated with CFCs is that they have been implicated as a major cause in the accelerated depletion of ozone in the Earth's stratosphere. Consequently, the use of CFCs has been severely restricted and even banned by many governments. In fact, under the recently instituted Montreal Protocol, CFCs are actively being withdrawn from all domestic, industrial and medical use. However, due to inability to find a better propellant to replace CFCs, they are still widely used in the medical field and health care industry, in spite of the harmful environmental side effects associated with their use.

Recently, there have been many attempts to find alternative propellants which offer the same advantages as CFCs, yet do not have any of the harmful environmental side effects. For example, HydroFluoroAlkane (HFA) has been used as a propellant in the medical field instead of CFCs. However, these propellants are disfavored by some patients due to their unpleasant taste and sensation. The HFA has a lower ozone damaging potential as compared to CFC, but has some global warming potential. Hence there are still some concerns about its widespread use. But since it is far better than CFC, its use has started increasing in the medical field as a propellant, mostly for lack of a better option.

In addition, some companies have started using dry powder technology (DPI) as a substitute for CFCs. However, DPI requires a very high flow rate to deliver the aerosol making them difficult to use for many applications, particularly medical applications. Recently, it has become more refined and now can be used in children up to 12 years of age. Still, it has its limitations and hence it is not used with a spacer or in younger age groups. Still further, other attempts include using mixtures of inert gases containing argon as the major gas included in an aerosol propellant. However, for various reasons these propellants have also not proved to be an adequate substitute.

Finally, numerous patents have been issued which are directed to the use of various aerosol propellants and related compositions, including U.S. Pat. Nos. 4,174,295; 4,380,505; 4,395,648; 4,595,522; 5,156,765; 5,164,177; 5,674,479; 5,711,292; 5,891,419; 6,007,793; 6,007,794; 6,056,946; 6,106,808; 6,106,809; 6,113,881; 6,136,884; and 6,309,624, said patents incorporated herein by reference. However, none of these patents is directed to the use of helium as a major propellant in aerosols.

Accordingly, there is a need to provide a propellant that is chemically inert, has a low boiling point, a low molecular weight, and is inexpensive and readily available. Moreover, there is a need to provide a propellant which is stable, nontoxic, nonflammable, and safe to use. Finally, there is a need to provide a propellant that does not display an unpleasant taste or smell and can readily be used for medical applications.

### SUMMARY OF THE INVENTION

It is thus an object of the present invention to provide an aerosol propellant in which helium is the primary ingredient. Helium is an ideal substitute for CFCs and other aerosol propellants because it meets all of the above-mentioned requirements. Moreover, helium does not have any of the harmful environmental side effects associated with other propellants, particularly CFCs.

Another object of the present invention is to provide a propellant composition which features a low boiling point so that it can be used in extreme temperatures.

A further object of the present invention is to provide a propellant with an extremely low molecular weight which achieves excellent penetration of the substrate.

Still another object of the invention is to provide a propellant which is safe for medical purposes.

In accordance with the present invention, these and other objects are achieved by providing a new propellant composition in which helium comprises the major component of the aerosol, preferably in the proportion of at least about 70% helium by weight, or preferably from about 70-100% by weight helium, based on the total weight of the propellant composition. In the preferred embodiment, helium should be used as the sole propellant, i.e., at a proportion of 100% of the propellant. Optionally, the propellant of the present invention may further be combined with a surfactant and/or other suitable ingredients included physiologically acceptable vehicles, carriers, excipients, or other materials normally used with conventional aerosol propellants.

Additionally, the present invention relates to an aerosol composition which includes a propellant which comprises at least about 70% helium, and preferably anywhere from about 70% to about 100% helium, most preferably 100% helium, along with a medicament, such as medicaments in particulate form that are suitable for use in aerosol compositions. The medicament may also be used in other forms, such as microcrystalline suspensions or aqueous solutions. In a pair of preferred embodiments, the medicament is either a bronchodilator or an anti-inflammatory steroid, or any other substance suitable for delivery to the respiratory system.

The present invention also provides a method of treating a medical ailment in a patient comprising the step of administering to a patient in need an effective amount of an aerosol formulation. The aerosol formulation includes a propellant which comprises at least about 70% helium, and preferably up to about 100% helium, and a medicament such as in particulate form. In one preferred embodiment, the medical ailments which are most frequently treated are asthma and allergic rhinitis, and the medicament may be a bronchodilator, an anti allergy/rhinitis medicine such as an anti-histamine, or other suitable drug.

Further features and advantages of the present invention will be set forth in, or apparent from, the detailed description of preferred embodiments thereof which follows.

### DETAILED DESCRIPTION OF THE INVENTION

In accordance with the present invention, a propellant composition is provided in which helium comprises a major component of an aerosol propellant, and in the preferred embodiment comprises at least about 70% helium by weight, and preferably from about 70% to about 100% helium by weight based on the total weight of the propellant formulation. The exact percentage of helium which is used will be determined by what other chemicals are added to the propellant, but in general, the higher the percentage of helium, the better result in terms of propellant action. Accordingly, the most preferred embodiment is one wherein helium is the sole propellant component, i.e., the propellant is 100% helium. However, as one skilled in this art would recognize, the actual concentration for any specific aerosol propellant in accordance with the invention will depend on many factors, e.g., type of medicament, surfactant, cosolvent, excipient and suspension/solution of chemical substance to be delivered. Optionally, additional chemicals may be added to the helium propellant, such as particular surfactants and particular medicaments as will be set forth in additional detail below.

Helium is an ideal replacement in a propellant for a number or reasons including the fact that it is a naturally occurring inert gas which is present as 0.0005% in our environment. As mentioned above, helium is an inert gas and has yet to be found to react with any other chemical substance. In nature, it only reacts with other helium atoms under extreme circumstances such as the rare event of contact with lightning which can result in the production of other elements including beryllium, carbon, and oxygen. Due to its inertness, the aerosol propellant of the present invention can be used in a number of different industries. Moreover, with the propellant of the present invention there is no risk of fire and the propellant is capable of being used with a variety of different chemicals without fear of chemical reaction.

The propellant of the present invention may be used with such devices as conventional metered dose inhalers (MDI's), nasal spray devices, as well as traditional aerosol containers. When used with a metered dose inhaler or nasal spray device for example, the propellant of the present invention may optionally include a suitable medicament, such as a particulate medicament, which is compatible with the aerosol formulation to be used with the MDI or other spray device, and dispersed therein. Examples of just some of the medicaments which are suitable to be administered as aerosol formulations according to the present invention include, for example, bronchodilators such as albuterol, salbuterol, terbutaline, metoproperanol, isoproterenol, epinephrine, salmetrol, alupent and isoetharine; anticholinergics such as ipratropium; anti-inflammatory steroids such as beclomethasone, flunisolide, and triamcinolone; anti-allergy medicaments such as nedocromil (tilade) and cromolyn; anti-angina medications such as Nitroglycerin; anti-smoking agents such as Nicotyl; and other miscellaneous medicaments such as synarel. However, as will be clear to one skilled in the art, still other medicaments are capable of being used with the propellant of the present invention. In the preferred formulations, the types of particulate medicament used are bronchodilators or anti-inflammatory medicines.

When used as a nasal spray device, the helium propellant may be utilized in any of the conventional formulations for applying an appropriate medicament. For example, typical medicaments used in nasal spray devices include an anti-histamine (e.g., one used for allergic rhinitis) and anti-enuresis (bed wetting) medicines which are currently available in the marketplace.

As would be recognized by one skilled in the art, there are numerous formulations for which the propellant of the present invention would be suitable, and indeed the present invention would be suitable for use with the MDI and other spray device formulations currently available and described herein, substituting the helium propellant of the present invention for the propellant compositions used in those inhalers and devices.

More preferably, the compositions of the present invention may be used to create aerosol formulations that may be used in specific instances to assist in particular conditions. For example, people with bronchial problems who need an inhaler with a bronchodilating agent may used the helium propellant compositions of the present invention. In one such preferred formulation, the bronchodilator used is albuterol, which is salbuterol sulphate in microcrystalline form. Albuterol is used in a formulation which includes alcohol as the solvent, an oleic acid dispersing agent, and preferably a 100% helium as the propellant. Still other bronchodilators useful in the present invention will be known drugs such as Salmetrol and Alupent.

Similarly, the present helium propellant of the invention may be used with an anticholinergic agent such as ipratropium bromide, preferably in microcrystalline form. In this preparation, the solvent used is alcohol, and the preferred dispersing agent is soya lecithin. The helium used as the propellant is preferably pure helium, i.e., 100% helium, and other possible dispersing agents such as Sorbitane trioleate can also be used in the compositions of the present invention.

Further, the present invention can be used to obtain propellant formulations useful with anti-inflammatory agents. For example, an aerosol composition using the anti-inflammatory agent Beclomethasone diproprionate, preferably in solution form, can be used with an alcohol solvent and an oleic acid dispersing agent. The preferable propellant is helium at 100% of the propellant composition by weight. Still other anti-inflammatory agents such as Fluticasone propionate and Flunisolide can also be utilized in accordance with the present invention.

Another aspect of the present invention relates to a method of treatment. The method comprises the step of administering an effective amount of a preferred formulation of the above formulation to a patient in need in order to treat a medical ailment. In one preferred method of treatment in accordance with the present invention, a particulate medicament such as a bronchodilator or an anti-inflammatory is added, e.g., when the medical ailment treated is asthma. The course of treatment as well as the exact amount to be administered will be determined of course by the condition of the patient as determined by a qualified physician. The medicament may be administered in a number of different ways for example, by such devices as MDI or nasal spray devices.

Among the many diseases treated with peptide or protein inhalation aerosols and which are thus useful with the aerosol propellant of the present invention include ARDS, AIDS, Anemic disorders, etc., as set forth in Table 3 of Adjei, “Clinical Development of Inhalants”, page 792, incorporated herein by reference. In addition, the present invention can be utilized with any of a number of some MDI formulations currently being marketed including Aerobid, Proventil, Ventolin, etc., as set forth at Table 6 of Gupta and Adjei, “Therapeutic Inhalation Aerosols”, page 208 , incorporated herein by reference. Both of these articles are included in the reference work “Inhalation Delivery of Therapeutic Peptidases and Proteins”, Edited by Akwete Lex Adeji and Pramod K. Gupta, published by Marcel Dekker, Inc., New York, and this work, which was supported by a grant from NIH, is herein incorporated by reference in its entirety.

Additionally, the new propellant of the present invention may further be used in conjunction with a surfactant. Aerosol formulations can include suitable surfactants according to the present invention, such as oleic acid, sorbitan trioleate, soya lecithin, and other surfactants known to be compatible in aerosol formulations. As will be clear to one skilled in the art the choice of surfactant as well as the exact formulation will be determined by the chemical substance (and its chemical and physical properties) to be delivered. In one specific embodiment of the present invention, a composition is provided which comprises a microcrystalline suspension of Albuterol Sulphate in the helium propellant along with an ethanol cosolvent and oleic acid as the surfactant.

Another feature of the helium propellant of the present invention is that it has an extremely low boiling point. This is due in large part to helium's low boiling point. Since the propellant has an extremely low boiling point it remains a gas even at extremely low temperatures. Accordingly, the propellant of the present invention is effective in any severe weather situation. For example, an instrument incorporating the propellant according to the present invention, such as an asthma inhaler, will work in all weather conditions. This is in contrast to other propellants which do not remain in gaseous form at all temperatures, and thus may not always function properly in extreme cold for example.

Still yet another advantageous feature of the helium propellant of the present invention is that it has an extremely light molecular weight, approximately 4 grams per mole. It is well known that the lighter the propellant, the deeper the penetration into the substrate. This is well exemplified by experimental comparisons between HFA and CFC. As such, helium being one of the lightest gases is capable of penetrating deeply into a given substrate. Due to its light weight, the propellant of the present invention will penetrate deeper into structures than other currently used propellants which have greater molecular weight such as HFA. As such, it will carry other substances such as surfactants and particulate medicaments deep with it and deposit them where they are needed. For example, when the propellant of the present invention is use in an asthma inhaler, it will carry the bronchodilator deep into the lungs, to the smallest airways (bronchioles), and will relieve bronchospasms. Thus, it will improve the human body's response to the bronchodilator. As helium will take medicine deeper, smaller doses of medicine will be required to get the same response, thus decreasing the chances of harmful side effects associates with a particular medicine.

Moreover, it is well established that helium is safe to use for medical purposes. Currently, it is known that helium is used to treat severe forms of respiratory distress even in pediatric age groups under the name of HELIOX® (a mixture of 70% helium with 30% O₂). Hence, no further medical testing will be required for its use in medical devices. Moreover, helium does not feature the bad taste or smell associated with other known propellants, specifically HFA.

Helium is obtained naturally from natural gas rich in helium by fractionation or from liquid air by fractional distillation. This is yet another advantage of using helium as a propellant since it is obtained exclusively from nature and goes back to nature, there will never be either a real shortage or excess in the environment. Consequently, there is no likelihood of any of helium imbalance in the environment and it is 100% environmental friendly. Moreover, since it is 100% environmentally friendly, it will not cause any special problems for disposal of any residual gas left in a container in which it is used. Finally the helium propellant of the present invention will not degrade the ozone layer and will thus not affect global temperature or have the potential to increase global warming.

In the preferred embodiment, the helium propellant of the present invention can be used in any conventional aerosol and thus its incorporation into a particular aerosol would be well known to one of ordinary skill in this art. For example, the production of aerosol propellants is well known in the prior art, including U.S. Pat. Nos. 4,595,522, 5,891,419 and 6,309,624, incorporated herein by reference. In general, the aerosol is created by taking the product, such as a liquid, emulsion or suspension, and adding the propellant which may be a liquefied or compressed gas. The result of the propellant is that the liquid product may be delivered in the form of an inhalant or spray which will generally have small droplets which can vary in size depending on the application. Still other aerosol formats may include foams, gels, etc. In these aerosols, it is the pressure of the propellant within the product container, e.g., the inhalant can, which pushes the product through the internal components of the applicator until it reaches an actuator and emerges as a spray or other format such as foam, gel, etc. In accordance with the present invention, the helium propellant of the invention will generally be used as a substitute for the conventional propellants currently being used in aerosols, and the present invention may be used in a wide variety of medical and non-medical products that currently are utilized in aerosol form.

Although the invention has been described above in relation to preferred embodiments thereof, it will be understood by those skilled in the art that variations and modifications can be effected in these preferred embodiments without departing from the scope and spirit of the invention.

The following Examples are provided are merely for illustrative purposes and do not in any way limit the scope of the invention as set forth in the claims appended hereto.

### EXAMPLES

The following examples describe particular formulations in accordance with the present invention.

### Example 1

### Anti-Inflammatory Compositions

A anti-inflammatory composition with a helium propellant in accordance with the present invention is prepared using 100% helium to form an aerosol composition including an anti-inflammatory agent. In this case, the anti-inflammatory substance utilized is Beclomethasone dipropionate in solution form in an alcohol solvent with a suitable dispersing agent such as oleic acid. Other suitable anti-inflammatory agents in accordance with the present invention include Fluicasone propionate and Flunisolide. Other suitable dispersing agents will include Sorbitane trioleate and the like. The amounts and proportions of the these ingredients will be the same or similar to those amounts and proportions utilized in current anti-inflammatory aerosol compositions, or other compositions employing propellants, with the exception that the helium propellant of the present invention, preferably at a percentage of 100%, will be employed instead of the conventional propellant being used in conventional anti-inflammatory preparations in the form which contains propellants.

### Example 2

### Bronchodilator Compositions

A bronchodilator composition with a helium propellant in accordance with the present invention is prepared using 100% helium to form an aerosol composition including a bronchodilator. In this case, the bronchodilator substance utilized is known as Albuterol, which is Salbuterol sulphate in microcrystalline form. This is used in an alcohol solvent with a suitable dispersing agent such as oleic acid. Other suitable bronchodilators useful in this example would be Salmetrol and Alupent. Other suitable dispersing agents will include Sorbitane trioleate and the like. The amounts and proportions of the these ingredients will be the same or similar to those amounts and proportions utilized in current bronchodilator aerosol compositions, or other compositions employing propellants, with the exception that the helium propellant of the present invention, preferably at a percentage of 100%, will be employed instead of the conventional propellant being used in conventional bronchodilator preparations in the form which contains propellants.

### Example 3

### Anticholinergic Compositions

An anticholinergic composition with a helium propellant in accordance with the present invention is prepared using 100% helium to form an aerosol composition including an anticholinergic agent. In this case, the anticholinergic agent utilized is known as Ipratropium bromide, preferably in microcrystalline form, which is preferably used with an alcohol solvent with a suitable dispersing agent such as soy lecithin. Other suitable dispersing agents will include Sorbitane trioleate, oleic acid and the like. The amounts and proportions of the these ingredients will be the same or similar to those amounts and proportions utilized in current anticholinergic aerosol compositions, or other compositions employing propellants, with the exception that the helium propellant of the present invention, preferably at a percentage of 100%, will be employed instead of the conventional propellant being used in conventional anticholinergic preparations in the form which contains propellants.

### Example 4

### Nasal Spray Formulations

In addition to the above formulations which are suitable, for example, in inhalants, the present invention may be utilized as a propellant in nasal spray devices as well. In one example, a nasal spray device may be prepared using an antiinflammatory agent such as Beclomethasone dipropionate in the form of a microcrystalline suspension. In such a formulation, a surfactant such as oleic acid may be employed, and the propellant is 100% helium in accordance with the invention. The percentages and proportions of these ingredients would be the same as in conventional nasal spray devices, with the exception that the helium propellant of the present invention is substituted for conventional propellants Still other anti-inflammatory agents that may be used in this formulation include Triamcinolone acetonide in microcrystalline suspension in alcohol, Budesonide in a micronized suspension, and Fluticasone propionate in a microfine aqueous suspension. Other surfactants such as sorbitan trioleate can also be used in this example.

Other suitable formulations which are in the form of nasal spray devices are also suitable for use in the present invention. For example, nasal sprays including an antihistamine agent (e.g., agents which treat allergic rhinitis) may also be prepared using the 100% helium propellant of the invention. In one example, a formulation using Azelastine hydrochloride in aqueous solution as the active ingredient and an oleic acid or soya lecithin surfactant is prepared using the 100% helium of the present invention. The proportions of the ingredients are the same as in conventional anti-histamine nasal sprays with the present example using the helium propellant of the present invention instead of the conventional propellants.

In addition, nasal sprays including an anti-cholinergic agent may also be prepared using the 100% helium propellant of the invention. In one example, a formulation using Ipratropium bromide in aqueous solution as the active ingredient and an oleic acid surfactant is prepared using the 100% helium of the present invention. The proportions of the ingredients are the same as in conventional anti-cholinergic nasal sprays with the present example using the helium propellant of the present invention instead of the conventional propellants.

Other suitable formulations in accordance with the invention include the use of nasal sprays with anti-enuresis (bed-wetting) agents. In one example, a nasal spray including an anti-enuresis agent such as Desmopressin acetate in aqueous solution as the active ingredient and an oleic acid surfactant is prepared using the 100% helium of the present invention. The proportions of the ingredients are the same as in conventional anti-enuresis formulations with the present example using the helium propellant of the present invention instead of the conventional propellants.

What is claimed is:

1. A propellant composition for use with an aerosol wherein the composition comprises at least about 70% of helium by weight, based on the total weight of the propellant composition.

2. The propellant composition of claim 1, wherein said propellant comprises 100% helium.

3. The propellant composition of claim 1, wherein said propellant further comprises a surfactant or cosolvent.

4. The propellant composition of claim 1, wherein said propellant further comprises a physiologically acceptable vehicle, excipient or carrier.

5. The propellant composition of claim 1, wherein said aerosol is in the form of a spray, foam or gel.

6. An aerosol composition comprising:
a propellant, said propellant comprising at least about 70% of helium by weight, based on the total weight of the propellant composition;
and a medicament suitable for use in an aerosol composition.

7. The aerosol composition according to claim 6, wherein the propellant is 100% helium.

8. The aerosol composition according to claim 6, wherein the medicament is in the form of a microcrystalline suspension or an aqueous solution.

9. The aerosol composition according to claim 6, wherein the medicament is selected from the group consisting of bronchodilators, anticholinergics, anti-inflammatory agents, anti-allergy medicaments, anti-angina medications, anti-histamines, anti-enuresis agents and anti-smoking agents.

10. The aerosol composition according to claim 6, wherein the medicament is a bronchodilator selected from the group consisting of albuterol, salbuterol, terbutaline, metoproperanol, isoproterenol, epinephrine, and isoetharine

11. The aerosol composition according to claim 6, wherein the medicament is an anti-inflammatory steroid selected from the group consisting of beclomethasone, flunisolide, and triamcinolone.

12. The aerosol composition according to claim 6, further comprising a surfactant or a cosolvent.

13. The aerosol composition according to claim 6, further comprising a physiologically acceptable vehicle, excipient or carrier.

14. A method of treating a medical ailment in a patient comprising the step of administering to a patient in need an effective amount of an aerosol formulation, said aerosol formulation having a propellant comprising at least about 70% of helium by weight, based on the total weight of the propellant composition, and a medicament.

15. The method according to claim 14 where the propellant is 100% helium.

16. The method according to claim 14, wherein said aerosol formulation is administered to the patient by means of a metered dose inhaler (MDI) or a nasal spray device.

17. The method according to claim 14, wherein said medical ailment is bronchial asthma or allergic rhinitis.

18. The method according to claim 14, wherein said medicament is selected from the group consisting of bronchodilators, anticholinergics, anti-inflammatory agents, anti-allergy medicaments, anti-angina medications, anti-histamines, anti-enuresis agents and anti-smoking agents.

19. The method according to claim 14, wherein said medicament is a bronchodilator selected from the group consisting of albuterol, salbuterol, terbutaline, metoproperanol, isoproterenol, epinephrine, and isoetharine.

20. The method according to claim 14, wherein said medicament is an antiinflammatory steroid selected from the group consisting of beclomethasone, flunisolide, and triamcinolone.
